(19) United States
(12) Patent Application Publication
(10) Pub. No.: US 2024/0102806 A1
(43) Pub. Date: Mar. 28, 2024

(54) METHOD OF SYNCRONISING DATASETS

(71) Applicant: APPY RISK TECHNOLOGIES LIMITED, Crewe, Cheshire (GB)

(72) Inventor: Robert MADDOCK, Crewe, Cheshire (GB)

(73) Assignee: APPY RISK TECHNOLOGIES LIMITED, Crewe, Cheshire (GB)

(21) Appl. No.: 18/266,417

(22) PCT Filed: Dec. 10, 2021
(86) PCT No.: PCT/GB2021/053241

§ 371 Date: Jun. 9, 2023

(30) Foreign Application Priority Data
Dec. 10, 2020 (GB) 2019516.0

(51) Int. Cl. G01C 21/00; G01C 21/28

(52) U.S. Cl. CPC G01C 21/005; G01C 21/28

(57) ABSTRACT

A method of synchronising a dataset of data from at least one first sensor using data from at least one second sensor based on calculation of a cross-correlation between the respective magnitudes of at least one parameter from the first data set and the second data set then identifying a synchronisation time offset corresponding to a maximum correlation between the respective magnitudes of at least one parameter from the first data set and the second data set and applying the synchronisation time offset to the second data set to synchronise the second data set with the first data set.

### TECHNICAL FIELD OF THE INVENTION

The present invention relates generally to the field of vehicle telematics and impact detection. In particular, but not exclusively, the invention concerns a method of synchronising a dataset of data from at least one first sensor using data from at least one second sensor.

### BACKGROUND TO THE INVENTION

A telematics device or device used to capture telematic information may be provided with more than one component to capture information. For example, an accelerometer to capture acceleration data and access to a GPS receiver, typically to capture location, course and/or speed information may be provided.

The data captured from the different components will typically not be synchronized. This can occur for a variety of reasons but perhaps the main reason is that some devices operate smoothing or filtering software to smooth or filter the raw information captured. This smoothing or filtering can delay the information, therefore causing differences in time in different datasets. Other reasons exist for the datasets becoming out of sync.

In situations where a decision is to be made in relation to an incident but based on information from more than one dataset, the accuracy of the decision will be adversely affected, or at least be made more difficult if the information in the datasets is not synchronised.

Embodiments of the invention seek to at least partially overcome or ameliorate any one or more of the abovementioned disadvantages or provide the consumer with a useful or commercial choice.

### SUMMARY OF THE INVENTION

According to a first aspect of the invention there is provided a method of correcting for synchronising a dataset of data from at least one first sensor using data from at least one second sensor, the method comprising the steps of:
collecting first data in a first data set over a time period, t;
collecting second data in a second data set over a time period, t;
calculating a magnitude of at least one parameter from the first data set;
calculating a magnitude of at least one parameter from the second data set;
calculating a cross-correlation between the respective magnitudes of at least one parameter from the first data set and the second data set;
identifying a synchronisation time offset corresponding to a maximum correlation between the respective magnitudes of at least one parameter from the first data set and the second data set; and
applying the synchronisation time offset to the second data set to synchronise the second data set with the first data set.

The method may be particularly configured to synchronise position data and acceleration data to correct for any smoothing in the position data. The at least one parameter may be acceleration in at least one direction.

In another aspect, there is provided a system for synchronising position data and acceleration data, the system comprising a mobile computing device having at least one on board acceleration sensor for collecting acceleration data and at least one position sensor for collecting position data, and a software application operating on an onboard processor for implementing a method of synchronising position data and acceleration data based on the position data and acceleration data collected.

The mobile computing device may be a smartphone or tablet or similar device. The mobile computing device may be an in-vehicle information capture device.

The first data in the first data set and the second data in the second data set will typically relate to the same at least one parameter. In an embodiment, the at least one parameter is acceleration. The at least one first sensor and at least one second sensor may sense or capture information in relation to different parameters but the at least one parameter used to synchronise the respective datasets will typically at least be derivable from the respective parameters sensed by the at least one first sensor and at least one second sensor.

The system will typically require at least one first sensor to collect the first data in the first data set. The system will typically require at least one second sensor to collect the second data in the second data set. The at least one first sensor may be or include at least one acceleration sensor. The at least one second sensor may be or include at least one position sensor.

The at least one first sensor and at least one second sensor may be provided on any device for example a smartphone or similar could be used as these devices typically include at least one acceleration sensor typically in the form of an accelerometer and at least one position sensor typically in the form of a GPS receiver.

The system may comprise an information capture device for vehicle monitoring having at least one on board acceleration sensor for collecting acceleration data and at least one position sensor for collecting position data relating to a vehicle.

Providing a method of synchronising a dataset of data from at least one first sensor using data from at least one second sensor allows the utilisation of the data from both datasets in decision making which increases the precision and/or accuracy of the decision making and/or recognition of anomalies in one of the datasets.

Although not limited to the synchronisation of datasets relating to telematics information or information in relation to a vehicle, the method and system of the invention may be described with reference to vehicle telematics. In one embodiment, the method may be implemented in a software application. The software application may operate on any device. Typically, the software application will operate on a mobile computing device. The software application may choose information to be synchronised. For example, the software application may choose a dataset relating at least one acceleration sensor and a dataset from at least one position sensor, captured from the same device. The software application may choose one or more datasets captured by one or more different sensors on one or more different devices to be synchronised.

Typically, the software application will ensure that any parameter to be used as the basis for the correction is identified/isolated from the one or more datasets. Typically, any parameter which is identified/isolated from the one or more datasets will be identified/isolated with a related time. The time may be represented in any way. For example, the time may be represented as a timestamp (which may require conversion into a recognised time format) or the time may be present in a recognised time format. Typically, the related time will be retained with the data in the dataset. Each time point in the time period, t, in the dataset will typically have a value for the parameter which is to be used as the basis for the correction or have a value for one or more secondary parameters from which the at least one parameter which is to be used as the basis for the correction can be calculated.

The at least one parameter to be used as the basis for the correction may not be captured directly. For example, information captured from an accelerometer will normally be acceleration information, but information captured from a GPS receiver does not typically include acceleration information. However, the information captured from a GPS receiver is typically sufficient for acceleration information to be derived from the information captured. The software application may therefore undertake one or more calculations to identify/isolate information relating to the parameter it to be used as the basis for the correction from one or more of the datasets.

Position or location information may include speed and/or course information. Whilst these can be derived from position, some GPS chipsets calculate speed from doppler shift much more accurately. If one or more additional sensors are provided, information from one or more of these additional sensors can be utilised to improve the information to be utilised for example correct course information may be corrected using a magnetometer, therefor enhancing the accuracy over solely position or location information.

Normally, the data is collected at a particular frequency. Any frequency may be chosen. The data can be processed using the particular frequency in which the data is collected. The data can be processed using a frequency which is different to, typically less than the frequency in which the data is collected. In an embodiment, the data is collected at a frequency of 100 Hz. The data may be processed using this frequency. A lesser (or greater) frequency may be used to reduce the amount of processing required. For example, the data may be collected at a frequency of 100 Hz but processed at a frequency of 1 Hz. If the data in respective dataset is collected at different frequencies, then the data will typically be processed at the same frequency. Conversion may be required. The conversion may take place on any basis such as for example an average may be used. It is important that the same parameter be used as the basis for the correction in each of the datasets and that the datasets have the same time unit basis.

The sensors will normally capture input information at a known frequency. The frequency may be selected for optimum information processing balancing the amount of information to be processed with the speed of processing. For example, information may be captured at one frequency and processed at another frequency. A capture frequency of 100 Hz has been found to be optimum but a higher or lower capture frequency could be selected.

In an embodiment, the acceleration data is collected using an accelerometer. The accelerometer will normally be a multi-axis accelerometer. The software application may orient the data captured with the axes of the vehicle. The software application may then calculate the magnitude of acceleration in any one or more of the axes. For example, the software application will typically calculate the magnitude of the x-axis and y-axis acceleration.

In an embodiment the location or position data is collected using a GPS receiver as mentioned above. The software application may typically use the speed information and the course information provided from the GPS receiver to calculate the course change rate multiplied by the speed. The software application may calculate the acceleration in the x-axis and the y-axis using course change rate multiplied by the speed information. The software application may calculate the magnitude of the GPS based acceleration in the x-axis and y-axis.

Once the x-axis and y-axis acceleration magnitudes of both the accelerometer data and the GPS receiver data have been calculated, the software application can then calculate a cross-correlation between the two datasets using the x-axis and y-axis acceleration magnitudes in the respective datasets.

The data in the datasets will typically be offset due to the smoothing or filtering for the reasons explained above. The software application will typically allow for a time offset between the data in the respective datasets. The allowed time offset will typically be plus or minus 10 seconds, but are smaller time offset such as plus or minus 5 seconds may be used. The allowed time offset cannot be too long because this will lead to a lower cross-correlation but similarly, the allowed time offset cannot be too short. An allowed time offset of between 5 seconds and 10 seconds, typically closer to 10 seconds has been found to be optimal. The time offset will preferably be not more than ±30 seconds.

The software application will preferably calculate a cross-correlation between the datasets at different time offsets in order to identify the time offset which provides the best or maximum cross-correlation.

The data in the respective datasets may be smoothed or filtered. Preferably, any smoothing or filtering will take place after the calculation of the cross-correlation between the datasets. Any method of smoothing or filtering may be used. For example, a polynomial filter or least-squares filter could be used. A multipoint cubic Savotzsky Golay filter could be used but this is simply one filter which has been found to be appropriate and any similar method may be used. A five-point Savotzsky Golay filter may be used.

The software application can then apply the identified time offset corresponding to the maximum correlation to one of the datasets in order to synchronise that dataset with the other of the datasets.

Smoothing or filtering the data after the cross-correlation has been calculated, retains sufficient granularity of the data upon which the synchronisation occurs to allow the datasets to be synchronised with a high degree of accuracy.

### DETAILED DESCRIPTION OF THE INVENTION

In order that the invention may be more clearly understood one or more embodiments thereof will now be described, by way of example only, with reference to the accompanying drawings, of which:

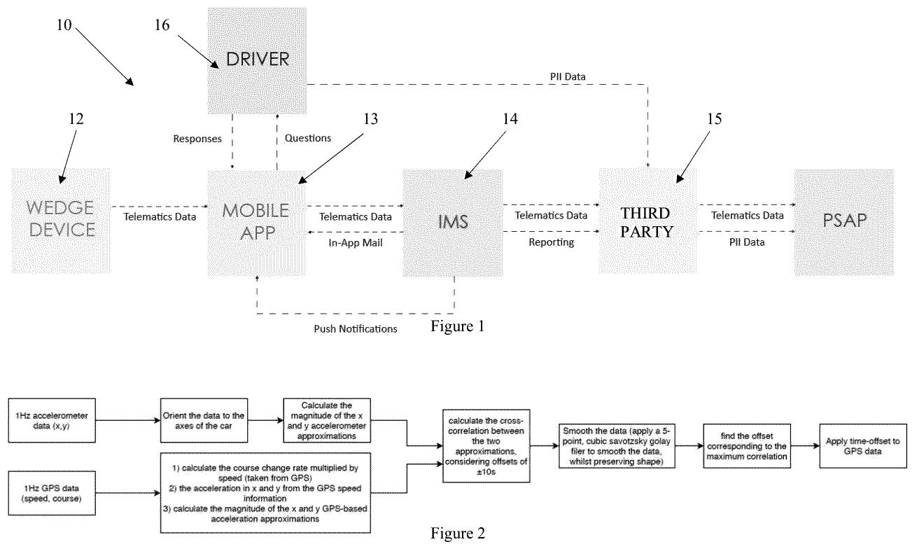

FIG. 1 is a schematic diagram of hardware components of a system of an embodiment.

FIG. 2 is a flow diagram showing a synchronisation methodology according to an embodiment.

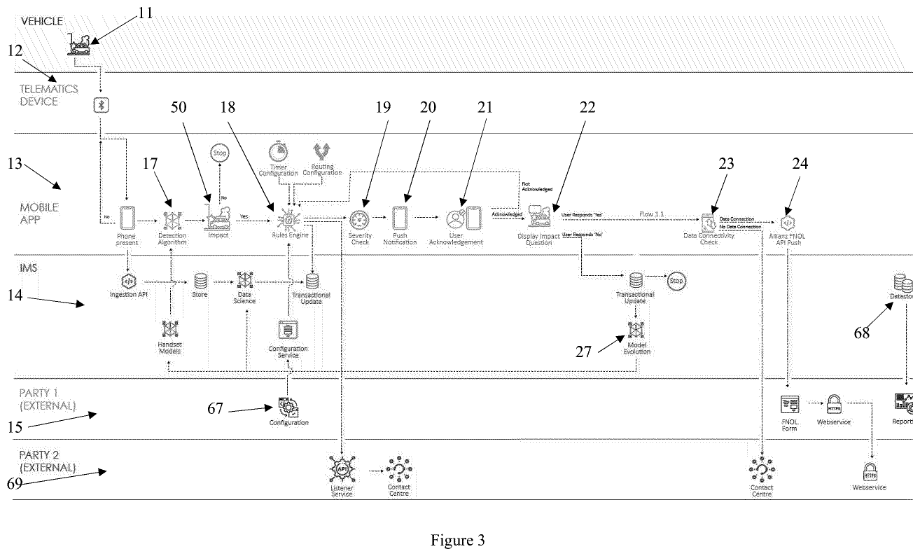

FIG. 3 is a schematic diagram showing a division of functionality between hardware components of a system of an embodiment.

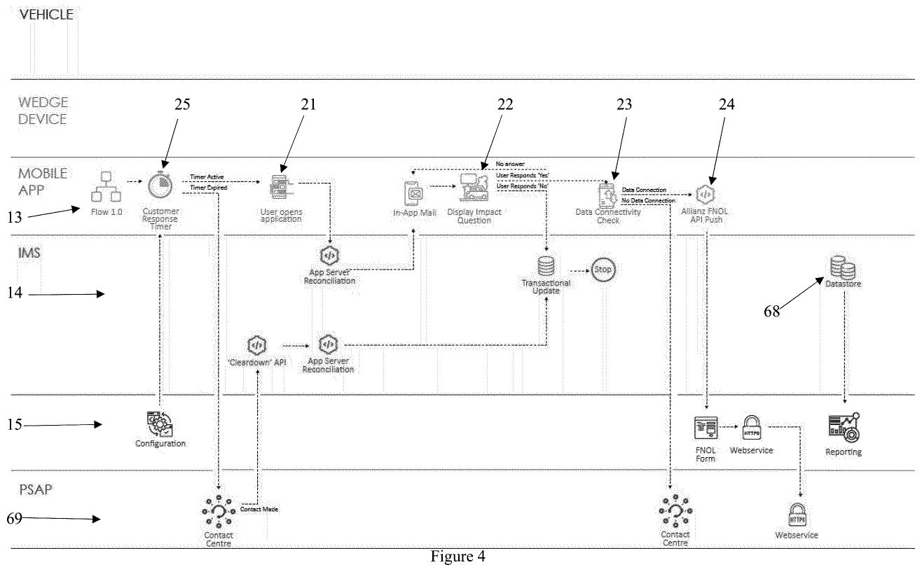

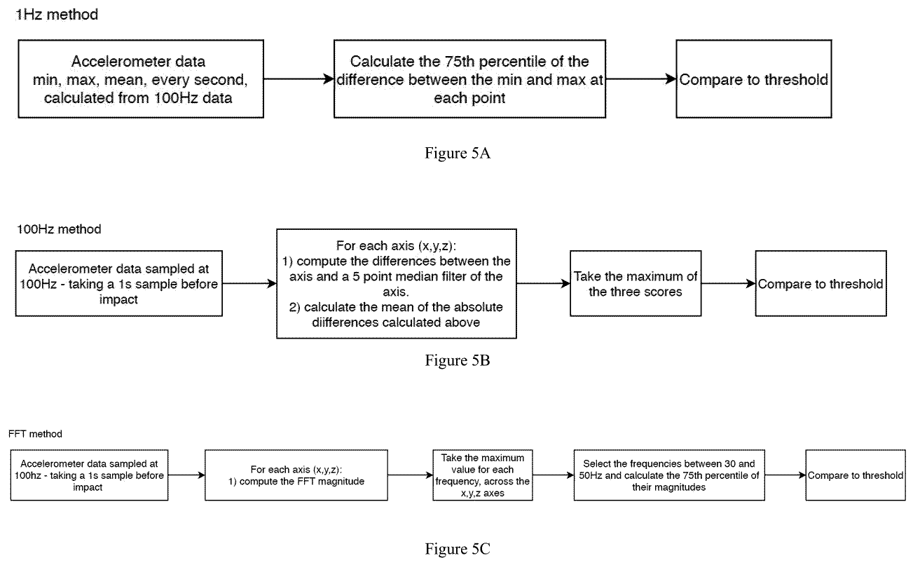

FIG. 4 is a schematic diagram showing a division of functionality between hardware components of a system of the embodiment illustrated in FIG. 3.

FIG. 5A is a flow diagram showing a first mount security detection method according to an embodiment.

FIG. 5B is a flow diagram showing a second mount security detection method according to an embodiment.

FIG. 5C is a flow diagram showing a third mount security detection method according to an embodiment.

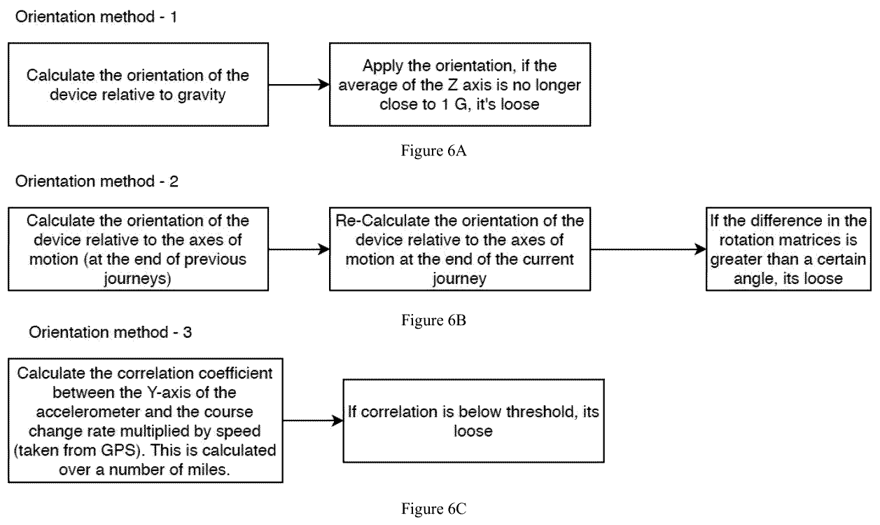

FIG. 6A is a flow diagram showing a first orientation detection method according to an embodiment.

FIG. 6B is a flow diagram showing a second orientation detection method according to an embodiment.

FIG. 6C is a flow diagram showing a third orientation detection method according to an embodiment.

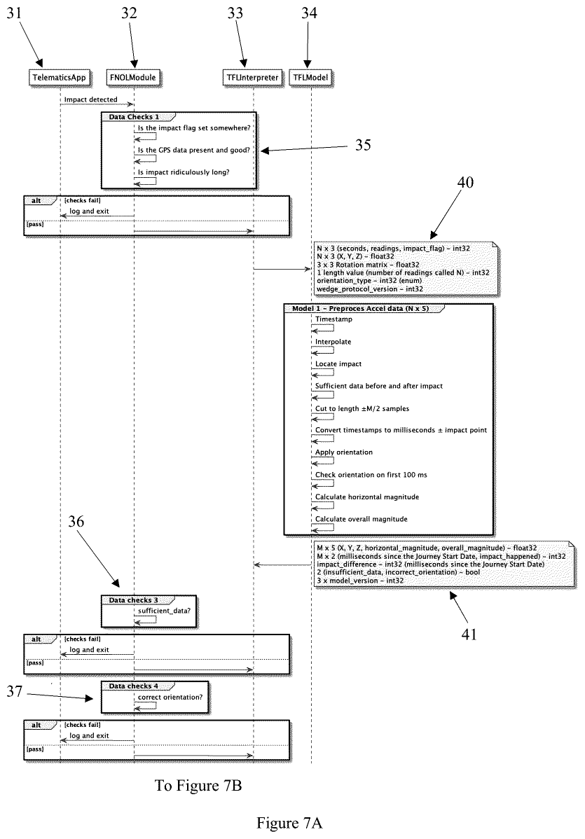

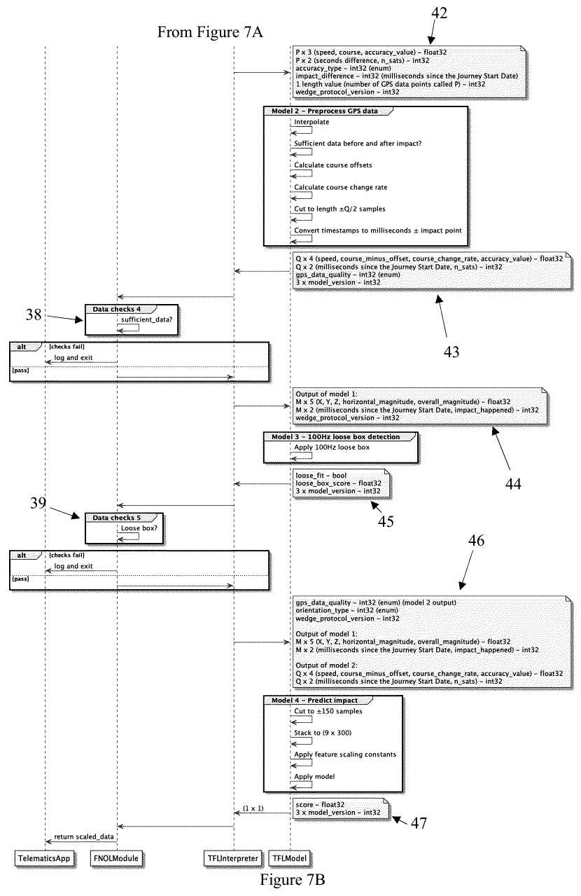

FIG. 7A is a flow diagram of a first part of a general system algorithm according to an embodiment.

FIG. 7B is a flow diagram of a second part of a general system algorithm according to an embodiment.

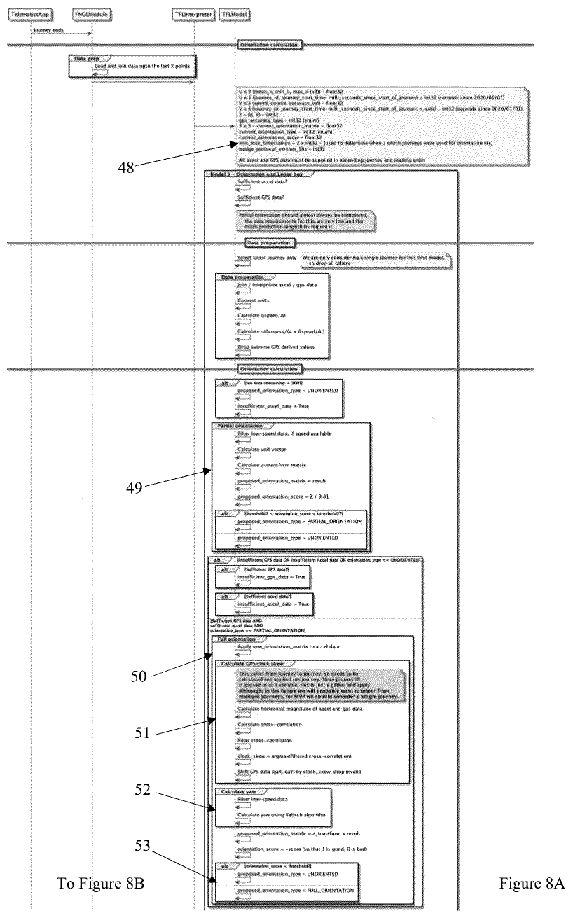

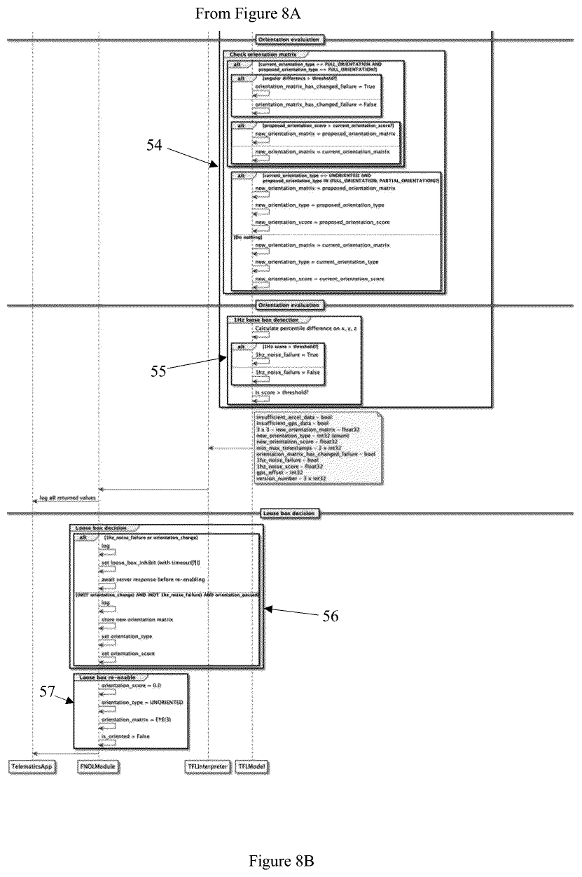

FIG. 8A is a flow diagram of a third part of a general system algorithm according to an embodiment.

FIG. 8B flow diagram of a fourth part of a general system algorithm according to an embodiment.

With reference to the accompanying figures, an embodiment of a crash detection system and component methodologies therefor, are shown.

A general schematic of a crash detection system 10 for a vehicle 11 is illustrated in FIG. 1.

FIG. 1 shows an in-vehicle information capture device 12 which captures telematic information and transmits the captured telematic information to a portable computing device such as a smartphone operating a detection software application 13. The smartphone is normally in the same vehicle as the in-vehicle information capture device 12.

The in-vehicle information capture device 12 and the smartphone are typically connected via a communication standard such as Bluetooth®, WiFi®, NFC, radio, optical or similar.

The in-vehicle information capture device 12 preferably includes a number of different sensors to capture input information in relation to measurable parameters relating to the vehicle. Typically, the device includes a number of sensors configured to capture different types of information. The different types of information will typically be captured from the sensors contemporaneously. The advantage of capture of different types of information contemporaneously is that analysis of different types of information captured contemporaneously may reveal more than analysis of a single type of information.

The in-vehicle information capture device 12 may include one or more accelerometer preferably used to detect the orientation of the device, usually capturing information relating to the linear acceleration of movement.

The in-vehicle information capture device 12 may include one or more gyroscope, to add an additional dimension to information supplied by the preferred accelerometer, by capturing information relating to angular rotational velocity.

The accelerometer will typically measure the directional movement of a device but will normally not be able to resolve its lateral orientation or tilt during that movement accurately unless the gyroscope is there to fill in that information.

A multi-axis accelerometer may be combined with a multi-axis gyroscope to provide information in relation to the orientation of the device that is both clean and responsive in the same time.

The provision of the sensors in the in-vehicle information capture device 12 may allow the in-vehicle information capture device 12 to determine a variety of parameters relating to the vehicle including location, speed or travel but also other information such as the orientation of the vehicle.

The portable computing device or smartphone or tablet or other portable computing device will normally include sufficiently powerful communications components to undertake long range communications. The portable computing device or smartphone or tablet or other portable computing device typically be able to offload data via one or more communications pathways available to it as and when the one or more communications pathways are available. The portable computing device will normally include a short-range wireless transceiver (this may be the same transceiver as the long-range transceiver or a separate unit). The portable computing device or smartphone or tablet or other portable computing device can select between the one or more communications pathways available to it.

Typically, the portable computing device may include at least one on-board accelerometer. Typically, the portable computing device may include at least one on-board gyroscope. Typically, the portable computing device may include at least one on-board magnetometer. Typically, the portable computing device may include at least one barometer. Typically, the portable computing device may include at least one on-board navigation component/system. Normally, a smartphone or tablet, for example, will include a Global Navigation Satellite System (GNSS) component. However, these sensors, when provided on a smartphone or tablet for example, do not always capture information reliably, and usually, any one or more of the sensors identified, may typically be provided in the in-vehicle information capture device.

Typically, the portable computing device may include at least one on-board storage component. Preferably the at least one storage component will be or include electronic storage. The electronic storage will typically be non-volatile storage.

Typically, the portable computing device may include at least one on-board long-range wireless transceiver. The long-range wireless transceiver may be configured to send and receive information to and from an associated short-range transceiver, such as from the device. The long-range wireless transceiver may be configured to send and receive information to and from an associated remote location.

In an embodiment, the smartphone therefore has access not only to the telematics data collected by the in-vehicle information capture device 12, but also to information from hardware components of the smartphone itself.

The software application operating on the smartphone typically uses data available to it, to undertake impact or collision monitoring and make decisions on when an impact or collision has been detected. The software application operating on the smartphone will normally issue questions or notifications to the driver of the vehicle and receive a response to any questions or notifications. The software application operating on the smartphone will also make decisions based on the driver's answer(s) (or non-answers) and if an impact is detected by the software application operating on the smartphone and confirmed by the driver, the software application operating on the smartphone will typically confirm this with at least one third-party.

The software application operating on the smartphone will typically also provide information regarding decisions and/or events to a server software application operating on a central computer system or network 14.

The server software application operating on a central computer system or network 14 may undertake more detailed analysis of the information and/or decision and may report separately to the at least one third-party.

As illustrated in FIGS. 3 and 4, the in-vehicle information capture device 12 will typically undertake an initialisation protocol according to which the in-vehicle information capture device 12 checks whether the smartphone is present or not. This may occur directly or indirectly. The initialisation protocol may be triggered when a smartphone with a communications pathway, such as Bluetooth® for example, enters into a specified proximity of the in-vehicle information capture device 12.

If a smartphone operating the detection software application is detected, the in-vehicle information capture device 12 will transmit the captured information to the smartphone. If a smartphone operating the detection software application is not detected, then the in-vehicle information capture device 12 will normally temporarily store the captured information in onboard memory until an appropriate download or transmission can be made.

The smartphone will typically utilise the telematic information that is provided by the in-vehicle information capture device 12 to detect the occurrence of a collision or impact. The smartphone will preferably undertake this detection according to a detection algorithm in the detection software application.

Once a collision or impact is detected by the detection algorithm 17 operating on the smartphone, the detection software application 17 will then typically undertake a further assessment of the detected collision or impact 50 and take action based on that further assessment.

The further assessment is preferably governed by a rules engine 18. The rules engine 18 will normally have access to various types of information/inputs including the telematic data upon which the collision or impact is detected. The rules engine 18 may utilise information from a timer. The rules engine 8 may utilise routing information in relation to a vehicle route. The rules engine 18 will preferably undertake a severity check 19 of the collision or impact detected utilising information available to the rules engine 18.

If the severity of the impact is above a threshold (some impacts may be relatively minor), the software application operating on the smartphone will preferably cause a request for acknowledgement message (push notification) 20 to be issued to the driver 16 of the vehicle. The purpose of the request for acknowledgement message is to enable the system to recognise whether the driver 16 has access to the smartphone after the collision or impact has occurred which may not be the case if the driver 16 is unconscious or the smartphone is out of reach for example. If the driver 16 does not acknowledge the message, then the software application may be capable of issuing notifications to one or more third parties 69 possibly regarding the location of the vehicle (as the smartphone will have access to position information), the status of the vehicle or the like, possibly to emergency responders or to a listening service.

When the driver 16 acknowledges (at step 21) which may be by the driver opening the software application as shown in FIG. 4, the software application operating on the smartphone may then request confirmation that a collision or impact has occurred.

As shown in FIG. 4, there will normally be a timer applied to the confirmation that a collision or impact has occurred. The length of the time available may be defined by a third party, such as an insurer for example. If the time period expires without the driver responding, the software application operating on the smartphone may contact a third party, such as a contact centre to request that the contact centre make contact with the driver.

If the driver responds 21 (this may occur in any way, such as, for example, by the driver opening the software application operating in the background of the smartphone) while the time period is still active, the impact question may be displayed 22, querying whether an impact has occurred.

If the driver 16 responds in the positive (to indicate that a collision or impact has occurred) then the software application operating on the smartphone will preferably check that it has data connectivity 23 and if it does, the smartphone will preferably report 24 the collision or impact to a third-party computer server or network 15.

If the driver responds in the negative (to indicate that a collision or impact has not occurred) then the software application operating on the smartphone will preferably end the process and report to a central computer server or network 14.

If no response is received, then the software application operating on the smartphone may again request confirmation that a collision or impact has occurred.

The third party 15 may be or include an insurer. In this way, once an impact or collision is detected, the incident can be analysed based on the telematics information collected by the in-vehicle information capture device 12 (and any other information that the software application has access to) and reported immediately. Preferably, the incident is also reported to the central computer server or network 14 of the system.

The impact detection decision is preferably made by the software application operating on the smartphone and if an impact is detected, the software application operating on the smartphone may then request confirmation that a collision or impact has occurred from a user (typically the driver) and once confirmation is received, the software application operating on the smartphone may then notify at least one third party 15 such as an insurer directly.

The smartphone operating the detection software application is typically connected via an appropriate communication standard to a central computer server or network 14. The smartphone will typically transmit information to the central computer server or network 14 and receive information from the central computer server or network 14.

In particular, the central computer server or network will preferably store the information transferred from the detection software application. The central computer server or network will also typically configure the impact detection algorithm and provide updates to a detection algorithm to the smartphone. Any evolution 27 of the impact detection algorithm or part thereof, may be accomplished using machine learning.

The central computer server or network will typically be associated with a datastore 68 for storing the data from the system. This data includes information sent to the central computer server or network 14 from the in-vehicle information capture device 12 as well as information produced by the server software application operating on the central computer server or network 14.

The central computer server or network may also be configured to allow configuration information 67 to be provided to the server software application from third party systems 15. This may be particularly useful where a third-party system 15 such as a vehicle insurer for example, wishes to define one or more parameters to take into account when determining what severity of collision or impact should be reported. This information may be provided from the third-party system to a configuration service in the server software application operating on the central computer server or network, and from there, to the rules engine in the detection software application operating on the smartphone.

The server software application operating on the central computer server or network 14 may contain more advanced analytics than the detection software application operating on the smartphone. The detection software application operating on the smartphone is preferably able to arrive an impact or collision detection decision more quickly as it is in the vehicle. The detection software application operating on the smartphone will also usually have more immediate access to more information upon which to base the decision. All of the information upon which a decision is made is generally also transmitted to the server software application operating on the central computer server or network for more in-depth analysis and/or event reconstruction.

The server software application operating on the central computer server or network 14 will typically also be provided with the information upon which a positive impact or collision detection decision is made and this information may be used to evolve the detection algorithm. This step is preferably independent of the notification to the at least one third party, that is a positive impact or collision detection decision is typically notified directly to the at least one third party from the smartphone.

Preferably, evolution 27 of the impact detection algorithm or any part thereof, which is a part of the detection software application on the smartphone, will take place primarily in the server software application operating on the central computer server or network 14. An updated detection algorithm can then be pushed out to the detection software application on the smartphone as illustrated in FIG. 3. This will preferably allow the server software application operating on the central computer server or network to maintain transparency and consistency in operation of the detection algorithm whilst also maintaining central control. The periodic updates of the detection algorithm from the server software application operating on the central computer server or network also mean that the detection algorithm can operate autonomously as required but any updates are centrally controlled by the server software application operating on the central computer server or network. Any update which takes place is fully controlled by the central computer server or network. The exact set of models in the software application on the smartphone is configurable down to the specific device and/or customer.

The server software application operating on the central computer server or network 14 will preferably utilise machine learning to evolve the impact detection algorithm or any part thereof.

The machine learning of the more complex algorithm of the server software application operating on the central computer server or network 14 and the updates to the detection algorithm operating on the smartphone periodically pushed to the smartphone ensure that the smartphone is utilising the learning of the more complex algorithm to ensure consistency of decisions but allowing the smartphone to use its more immediate access to more data for detection as well as reporting to the third party.

The smartphone operating the detection software application may also be connected via an appropriate communication standard to one or more third parties or third-party systems. The smartphone operating the detection software application may interface directly with a third-party system.

The software application operating on the smartphone may operate according to the general system algorithm illustrated in FIGS. 7A and 7B. The general algorithm illustrated is divided across four flow paths, one flow path 31 representing interactions with the in-vehicle information capture device 12, one flow path 32 representing processes undertaken in the operating language of the smartphone, one flow path 33 representing processes which are converted from the operating language of the portable computing device to a secondary language and one flow path 34 representing processes undertaken in the secondary language.

This form of the software application makes use of two different software languages and swaps functions between the two languages allowing interaction with the driver and the third party to be undertaken in the operating language of the smartphone, but to allow a secondary language to be used for the processing of the information. The secondary language is one which has been selected to provide better functionality for the different processing models within the general system algorithm.

As illustrated in FIGS. 7A to 8B, the general system algorithm is written in a series of blocks which occur in one or more of the flow paths. Generally speaking, data checks and reporting occur in the first, second or third flow path and the system models occur in the fourth flow path in the secondary language.

Operating the algorithm in the blocks as illustrated allows one or more of the blocks to be updated without updating the entire algorithm each time an update is made. It also makes jobs such as trouble shooting or debugging more straightforward as each block can be treated as an independent portion of the algorithm.

The data checks at the various stages in the algorithm are typically checking to see whether any required inputs are present and/or whether the output from one or more of the models meets the baseline condition being checked. For example, ‘Data Check 1’ 35 is the algorithm checking whether the impact flag is actually set within the system, whether GPS data is present and being delivered as required, and checks the length of the data. A threshold such as approximately 20 seconds may be used, as there may be back-to-back impacts from a multi-vehicle incident for example. Typically, an amount of data, usually more than 5 second and preferably more than 8 seconds of data, will be present for analysis as data is normally collected from before and after the impact for context. ‘Data Check 3’ 36 in FIG. 7A is the algorithm checking whether sufficient data is present for the algorithm to operate as required. ‘Data Check 4’ 37 in FIG. 7A is the algorithm checking to see whether the orientation of the in-vehicle information capture device 12 is correct to ensure that the data is interpreted correctly. ‘Data Check 4’ 38 in FIG. 7b is the algorithm checking whether sufficient data is present for the algorithm to operate as required. ‘Data Check 5’ 39 in FIG. 7B is the algorithm checking whether the output from Model 3 indicates that the in-vehicle information capture device 12 (‘the box’) is loose. At each data check, if the check is failed, then the algorithm logs the failure and exits. If the data check is passed, then the algorithm proceeds to the next block or model.

As mentioned above, each of the models used in the algorithm illustrated in FIGS. 7A to 8B are in a secondary language which is more appropriate for the calculations/testing undertaken than the language of the smartphone. The secondary language may be a more powerful processing language or not.

Box 40 shows the input data into Model 1.

Model 1 shown in FIG. 7A relates to the pre-processing of data from the accelerometer. This model locates the impact in the accelerometer data and then checks whether there is sufficient data available from before and after the impact. The model then crops the dataset around the impact which in turn allows a minimisation of the use of computing resources. The model converts the timestamp data into milliseconds to give a more realistic concept of time relative to the dataset. The model then checks whether the orientation of the in-vehicle information capture device 12 (‘the box’). The model then checks whether the orientation information on the data is correct. The model then calculates the magnitude of the acceleration in at least two axes (normally these two axes will be the X-axis and the Y-axis).

Box 41 shows the output data from Model 1.

Box 42 shows the input data into Model 2.

Model 2 relates to the pre-processing of data from the location device, in this case, a GPS receiver. This model locates the impact in the accelerometer data and then checks whether there is sufficient data available from before and after the impact. The model then calculates the course of the vehicle from the data and calculates the rate of change in the course. The model then crops the dataset around the impact which in turn allows a minimisation of the use of computing resources. The model converts the timestamp data into milliseconds to give a more realistic concept of time relative to the dataset.

Box 43 shows the output data from Model 2.

Box 44 shows the input data into Model 3 (which is the output from Model 1).

Model 3 in FIG. 7B uses the 100 Hz loose box detection algorithm illustrated in FIG. 5B but may be undertaken using any one or more of the methods shown in FIGS. 5A to 6C.

Box 45 shows the output data from Model 3.

Box 46 shows the input data into Model 4 (which is the output from Model 1 and output from Model 2).

Model 4 relates to the determination of the impact itself. Typically, this takes place utilising a portion of the information available (±150 samples in this example). Model 4 also preferably utilises a synchronisation of data from an accelerometer and positioning data such as that which may be gained from a GPS receiver, to ensure that the datasets from the respective components is aligned. A process such as that illustrated in FIG. 2 could be used.

Box 47 shows the output data from Model 4.

FIGS. 8A and 8B illustrate an algorithm undertaken after a journey has ended. As illustrated, the software application loads the data up until the journey has ended. Box 48 shows an example of the inputs to Model 5.

Model 5 as illustrated includes at least one determination or orientation and at least one loose box test. This embodiment undertakes a determination of partial orientation with respect to gravity (Box 49) and then once the partial orientation has been completed, undertakes a full orientation determination (Box 50). The full orientation determination illustrated includes a calculation of GPS clock skew (Box 51) followed by a yaw calculation (Box 52). Once that has been completed, an orientation score can be calculated and compared to the threshold (Box 53).

The orientation matrix is then checked and updated if it has changed (Box 54) as shown in FIG. 8B.

A 1 Hz loose box detection subroutine (one form is illustrated in FIG. 5A but it is important to recognize that the 75^{th} percentile may differ as required, that is a different percentile may be calculated) is then undertaken (Box 55).

The algorithm illustrated in FIG. 8B also includes a loose box decision subroutine in which the new orientation matrix and orientation score is set (Box 56). A loose box re-enable (Box 57) is then undertaken to prepare the application for the next journey.

As illustrated in FIG. 2, the method of correcting for synchronising a dataset of data from at least one first sensor using data from at least one second sensor comprises collecting first data in a first data set over a time period, t, collecting second data in a second data set over a time period, t, calculating a magnitude of at least one parameter from the first data set, calculating a magnitude of at least one parameter from the second data set, calculating a cross correlation between the respective magnitudes of at least one parameter from the first data set and the second data set, identifying a synchronisation time offset corresponding to a maximum correlation between the respective magnitudes of at least one parameter from the first data set and the second data set, and applying the synchronisation time offset to the second data set to synchronise the second data set with the first data set.

In the illustrated embedment, the at least one first sensor is an acceleration sensor and the second sensor is a position sensor with the at least one parameter used as the basis for the correlation being acceleration.

In an embodiment, the data is collected at a frequency of 100 Hz. The data may be processed using this frequency. A lesser (or greater) frequency may be used to reduce the amount of processing required. For example, the data may be collected at a frequency of 100 Hz but processed at a frequency of 1 Hz.

The acceleration sensor in the illustrated embodiment is a multi-axis accelerometer. The software application may orient the data captured with the axes of the vehicle. The software application may then calculate the magnitude of acceleration in any one or more of the axes. For example, as shown in FIG. 2, the software application will typically calculate the magnitude of the x-axis and y-axis acceleration.

In the embodiment illustrated in FIG. 2, the location or position data is collected using a GPS receiver. The software application will typically use the speed information and the course information provided from the GPS receiver to calculate the course change rate multiplied by the speed. The software application may calculate the acceleration in the x-axis and the y-axis using course change rate multiplied by the speed information. The software application may calculate the magnitude of the GPS based acceleration in the x-axis and y-axis.

Once the x-axis and y-axis acceleration magnitudes of both the accelerometer data and the GPS receiver data have been calculated, the software application can then calculate a cross correlation between the two datasets using the x-axis and y-axis acceleration magnitudes in the respective datasets.

The software application will typically allow for a time offset between the data in the respective datasets. The allowed time offset will typically be plus or minus 10 seconds, but are smaller time offset such as plus or minus 5 seconds may be used. The allowed time offset cannot be too long because this will lead to a lower cross-correlation and increase the amount of calculations to be performed but similarly, the allowed time offset cannot be too short. An allowed time offset of between 5 seconds and 10 seconds, typically closer to 10 seconds has been found to be optimal.

The software application will preferably calculate a cross-correlation between the datasets at different time offsets in order to identify the time offset which provides the best or maximum cross-correlation.

The data in the respective datasets may be smoothed or filtered. Preferably, any smoothing or filtering will take place after the calculation of the cross-correlation between the datasets. Any method of smoothing or filtering may be used, for example, a five-point Savotzsky Golay filter may be used.

The software application can then apply the identified time offset corresponding to the maximum correlation to one of the datasets in order to synchronise that dataset with the other of the datasets.

A number of loose box detection algorithms or methods are illustrated in FIGS. 5A to 6C. The algorithms or methods illustrated in FIGS. 6A to 6C are primarily directed toward detecting when the in-vehicle information capture device or box is completely loose within the vehicle and the algorithms or methods illustrated in FIGS. 5A to 5C are primarily directed toward detecting when the in-vehicle information capture device or box is fixed in position within the vehicle but is too loose to be reliable.

The software application will typically undertake a tiered detection. The software application will typically first determine whether the in-vehicle information capture device is completely loose (not fixed to any surface within the vehicle). If it is determined that the in-vehicle information capture device is fixed to a surface, the software application may determine whether the mounting of the in-vehicle information capture device is too loose to provide reliable and/or accurate information.

As shown in FIG. 6A, the software application may analyse acceleration data to calculate the orientation of the in-vehicle information capture device relative to gravity. The data from the at least one acceleration sensor can be monitored over time. For example, if the (average of) acceleration data of at least one of the axes does not remain relatively close to 1 g over time, then the in-vehicle information capture device will normally be completely loose. As mentioned above, it is normally acceleration in the vertical or z-axis which is monitored to determine whether the in-vehicle information capture device is completely loose.

Alternatively, the method may calculate the orientation of the in-vehicle information capture device relative to the axes of motion known from a previous time as shown in FIG. 6B. For example, the orientation of the in-vehicle information capture device will typically be fixed at the end of one journey and this is typically known or can be assumed at the start of the next journey. The method may calculate the orientation of the in-vehicle information capture device relative to the axes of motion at the end of a current journey and save this information for comparison purposes. The method may calculate the orientation of the in-vehicle information capture device relative to the axes of motion at the end of the previous journey. In the comparison, if the difference in the rotational matrices is greater than a predetermined angle between the end of the previous journey and the start of the current journey, then the in-vehicle information capture device is generally classified as completely loose.

Alternatively, a correlation coefficient may be calculated between acceleration data in at least one axis, and course change rate information available from a location sensor as shown in FIG. 6V. Generally, a location sensor (one example is a GPS receiver) will not capture acceleration data but will capture sufficient data from which acceleration data can be calculated or derived. Generally, this acceleration data is calculated using the course change rate (or rate of change in course or heading) multiplied by speed of travel. If the correlation coefficient calculated is below a predetermined correlation threshold, then the in-vehicle information capture device is generally classified as completely loose.

In one form, the mount security detection method may use the acceleration data to calculate minimum value, maximum value and a mean value of acceleration each second as shown in FIG. 5A. These values may be calculated over a number of axes, typically three axes, the x, y and z axes. As mentioned above, the data may be collected at a greater frequency, but in this form, the detection method preferably calculates a minimum value, a maximum value and a mean value of acceleration each second. The detection method may then calculate the 75th percentile of the difference between the minimum value and the maximum value at each point. This 75th percentile value can then be compared to a predetermined threshold to indicate whether the in-vehicle information capture device is loose or not.

In another form, the mount security detection method may use the acceleration data sample at a frequency greater than 1 Hz, such as 100 Hz as illustrated in FIG. 5B. The detection method may examine the data sample from a time period immediately before a possible impact. The time period is typically 1 to 2 seconds. Where a one second time period is used prior to a possible impact, there will be 100 data values if the collection frequency is 100 Hz. In this form, the detection method will preferably compute the differences between an acceleration point value measured and a smoothed or filtered value. Typically, the detection method will implement this for each axis of acceleration. Although any smoothed or filtered value may be used, a polynomial filter or an average value filter such as a five-point median filter may be used. The detection method may then calculate the mean of the absolute value of the differences. The detection method may then take the maximum value of the mean for from each of the averages (there will be three averages if there is an x, y and z axis, one for each axis) and compare the maximum value to a threshold.

In yet another form, the mount security detection method may use the acceleration data sample at a frequency greater than 1 Hz, such as 100 Hz but also examining the data sample from a time period immediately before a possible impact as shown in FIG. 5C. The time period in FIG. 5C is 1 second prior to a possible impact. Where a one second time period is used prior to a possible impact, there will be 100 data values if the collection frequency is 100 Hz. In this form, the detection method may compute the Fast Fourier transform (FFT) magnitude for each axis of acceleration. The detection method may then take the maximum value for each frequency, across the three acceleration axes. The detection method may then select the frequencies in a range, for example, between 30 and 50 Hz and calculate the 75th percentile of their magnitudes and compare the 75th percentile value to the threshold.

The threshold is typically set as a point value to denote “looseness”. The threshold may be set using a machine learning algorithm. The threshold may move dynamically over time.

The one or more embodiments are described above by way of example only. Many variations are possible without departing from the scope of protection afforded by the appended claims.

1. A method of correcting for synchronising a dataset of data from at least one first sensor using data from at least one second sensor, the method comprising:
collecting first data in a first data set over a time period, t;
collecting second data in a second data set over a time period, t;
calculating a magnitude of at least one parameter from the first data set;
calculating a magnitude of at least one parameter from the second data set;
calculating a cross-correlation between the respective magnitudes of at least one parameter from the first data set and the second data set;
identifying a synchronisation time offset corresponding to a maximum correlation between the respective magnitudes of at least one parameter from the first data set and the second data set; and
applying the synchronisation time offset to the second data set to synchronise the second data set with the first data set.

2. The method as claimed in claim 1 wherein the first data is acceleration data and the second data is position data to correct for any smoothing in the position data.

3. The method as claimed in claim 1 wherein the at least one parameter is acceleration in at least one direction.

4. The method as claimed in claim 1 wherein the first data in the first data set and the second data in the second data set relate to the at least one parameter.

5. The method as claimed in claim 4 wherein the at least one first sensor and at least one second sensor capture information in relation to different parameters but the at least one parameter used to synchronise the respective datasets is at least derivable from the different parameters sensed by the at least one first sensor and at least one second sensor.

6. (canceled)

7. The method as claimed in claim 1 implemented in a software application wherein the software application identifies and/or isolates the at least one parameter from the first dataset and/or the second dataset.

8. The method as claimed in claim 7 wherein the at least one parameter is identified/isolated with a related time such that each time point in the time period has a value for the at least one parameter which is to be used as a basis for the synchronisation.

9. The method as claimed in claim 1 wherein the first data and/or second data is collected at a particular frequency wherein the data is processed using the particular frequency in which the data is collected.

10. (canceled)

11. The method as claimed in claim 9 wherein the data is processed using a lower frequency than the frequency in which the data is collected.

12. The method as claimed in claim 9 wherein when the first data and the second data is collected at different frequencies, the data is processed at the same frequency.

13. A system of correcting for synchronising a dataset of data from at least one first sensor using data from at least one second sensor comprising a processing device operating a software application to implement the method as claimed in claim 1.

14. The system as claimed in claim 13 comprising at least one first sensor to collect the first data in the first data set and at least one second sensor to collect the second data in the second data set.

15. The system as claimed in claim 14 wherein the at least one first sensor is or includes at least one acceleration sensor and the at least one second sensor is or includes at least one position sensor.

16. The system as claimed in claim 15 wherein the at least one acceleration sensor is a multi-axis accelerometer.

17. (canceled)

18. The system as claimed in claim 16 wherein position data is collected using at least one position sensor and the software application uses speed information and course information provided from the at least one position sensor to calculate an acceleration magnitude in one or more axes.

19. The system as claimed in claim 18 wherein the software application can then calculate a cross-correlation between the first dataset and second dataset using acceleration magnitude in one or more axes, in the respective datasets.

20. The system as claimed in claim 19 wherein the software application calculates a cross-correlation between first data in the first dataset and second data in the second dataset at a number of different time offsets of between plus or minus 5 seconds and 10 seconds to identify the synchronisation time offset providing maximum cross-correlation.

21. (canceled)

22. (canceled)

23. A system comprising:
a. a mobile computing device having at least one on board acceleration sensor for collecting acceleration first data and at least one position sensor for collecting position second data, and
b. a software application operating on an onboard processor for implementing a method of synchronising the position second data and acceleration first data based on the position second data and acceleration data first collected.

24. The system as claimed in claim 23 wherein the mobile computing device is a smartphone or tablet or similar device.

25. The system as claimed in claim 23 wherein the mobile computing device is an in-vehicle information capture device.

26. (canceled)
